(19) United States
(12) Patent Application Publication
(10) Pub. No.: US 2012/0103655 A1
(43) Pub. Date: May 3, 2012

(54) OIL RESISTANT ELECTRONIC DEVICE AND METHOD FOR MANUFACTURING SAME

(75) Inventors: Tomonari Imabayashi, Kyoto (JP); Kyoji Kitamura, Kyoto (JP); Tomoyuki Nishida, Kyoto (JP); Kouji Yamamoto, Kyoto (JP); Hitoshi Hayashi, Kyoto (JP)

(73) Assignee: OMRON CORPORATION, Kyoto-shi, Kyoto (JP)

(21) Appl. No.: 13/259,742

(22) PCT Filed: Feb. 16, 2010
(86) PCT No.: PCT/JP2010/000938

§ 371 Date: Sep. 23, 2011

(30) Foreign Application Priority Data
May 27, 2009 (JP) 2009-127316

(51) Int. Cl. H01B 3/42; B05D 5/00

(52) U.S. Cl. 174/110 SR; 427/58

(57) ABSTRACT

An oil resistant electronic device is provided for preventing a chemical solution from penetrating a surface of a material and an interface between a cable and a jacket. The oil resistant electronic device does not cause defective connection even under severe conditions. The oil resistant electronic device includes a functioning section, a cable via which an electric signal is transmitted to the functioning section, and a jacket which covers the cable. The jacket is made of a polybutylene terephthalate resin composition containing a thermoplastic elastomer by 10 to 40 parts by weight with respect to 100 parts by weight of a polybutylene terephthalate resin, and the jacket covers the cable so as to cover an entire cross-section of at least one end of the cable and an outer layer of the cable by 2.5 mm or more in a lengthwise direction from the at least one end.

### BACKGROUND OF INVENTION

1. Technical Field

One or more embodiments of the present invention relate to (i) an oil resistant electronic device made of a resin composition having excellent flexibility and oil resistance and (ii) a method for producing the oil resistant electronic device.

2. Background Art

An engineering plastic such as a polyester resin is excellent in various properties such as strength, extensibility, and chemical resistance. Therefore, such an engineering plastic is used as a material of an electronic device such as a connector or sensor for use in an industrial machine.

Electronic devices such as connectors and sensors are configured such that a functioning section, such as a main body of the connector or a main body of the sensor, which has a function of the electronic device is provided at an end of a cable in view of easily providing electric wiring.

However, the polyester resin has low impact strength. This causes a breakage such as a crack, a chip, or a bend easily occurs in the electronic device made of the polyester resin during transportation or at installation. Moreover, a connector used in an industrial machine is often used under a high temperature condition, and therefore impact resistance of the connector is further decreased after a long-time usage. This causes a breakage such as a crack tends to easily occur.

As a remedy, it has been attempted to make the connector from a mixture prepared by mixing a polyester resin with a resin component having a flexible rubbery property (see Patent Literatures 1 and 2).

Moreover, for example, it has been proposed in these years to form the connector by using a new molded product, which attains excellent hydrolysis resistance, flexibility, and excellent impact resistance by mixing (i) polybutylene terephthalate having excellent hydrolysis resistance and (ii) a polyester-ether type elastomer (see Patent Literature 3).

Moreover, in the industrial machine use, the electronic device is inevitably used under severe environment such as being exposed to a chemical solution such as a machine oil. In view of this, it is necessary to prevent the chemical solution from entering the functioning section. Therefore, in these years, an attempt has been made to prevent material deterioration by improving chemical resistance and hydrolysis resistance of a material(s) of a cable itself and a jacket sealing the cable, in order to prevent the chemical solution from entering through a surface of the jacket due to the material deterioration (see Patent Literature 3).

### CITATION LIST

### Patent Literature

### Patent Literature 1

Japanese Patent Application Publication, Tokukaihei, No. 08-73698 (Publication Date: Mar. 19, 1996)

### Patent Literature 2

Japanese Patent Application Publication, Tokukai, No. 2004-143351 (Publication Date: May 20, 2004)

### Patent Literature 3

Japanese Patent Application Publication, Tokukai, No. 2007-291277 (Publication Date: Nov. 8, 2007)

### SUMMARY OF INVENTION

An electronic device such as a connector or a sensor has a configuration in which a functioning section, which has a function of the electronic device, is provided at an end of a cable. In such an electronic device the cable is, in general, at least partially covered with a jacket so that the cable is protected. In order to prevent the chemical solution from entering the functioning section, it is necessary to prevent the chemical solution from penetrating not only through a surface of a material of the cable or the jacket, etc., but also through an interface between the cable and the jacket.

However, the methods disclosed in the above mentioned related art documents cannot sufficiently prevent the chemical solution from penetrating through the interface between the cable and the jacket, even though the methods bring about, to a certain extent, an effect of preventing the chemical solution from penetrating through the surface of the material. Therefore, under a severe environment such as in a factory in which the electronic device contacts with a chemical solution such as a wax, a machine oil, or a cleaning fluid, the chemical solution flows along the cable and enters the functioning section through the interface. This has caused a decrease in insulation resistance at a contact point or a defective connection, which decreases reliability as the electronic device.

One or more embodiments of the present invention may provide a novel oil resistant electronic device which (i) can sufficiently prevent a chemical solution from penetrating not only through a surface of a material but also through an interface between a cable and a jacket, and therefore (ii) can secure high reliability because defective connection does not occur even when the oil resistant electronic device is used for a long time under severe environment in which the oil resistant electronic device is frequently exposed to a machine oil, etc. Moreover, one or more embodiments of the present invention may provide a method for producing the oil resistant electronic device.

An oil resistant electronic device of one or more embodiments of the present invention includes: a functioning section which has a function of the oil resistant electronic device; a cable via which an electric signal is transmitted to the functioning section; and a jacket which covers the cable, the jacket being made of a polybutylene terephthalate resin composition containing a thermoplastic elastomer and a polybutylene terephthalate resin where the thermoplastic elastomer is contained by 10 parts by weight to 40 parts by weight with respect to 100 parts by weight of the polybutylene terephthalate resin, and the cable being covered with the jacket so that the jacket covers (i) an entire cross section of at least one end of the cable and (ii) an outer layer of the cable by 2.5 mm or more from the at least one end in a lengthwise direction.

The inventors of the present invention produced, as described in Examples later, a cable covering jacket with the use of the polybutylene terephthalate resin composition and covered the cable of the electronic device with the cable covering jacket. In this jacket, the inventors found that, when the thermoplastic elastomer content is more than 40 parts by weight with respect to 100 parts by weight of polybutylene terephthalate resin, (i) oil resistance of the resin composition itself is lowered and, (ii) when the polybutylene terephthalate resin composition is used as an electronic device, the jacket and the cable, which is generally made of a material different from that of the jacket, are contacted with each other with less coherence at their interface (i.e., the jacket less tightly wraps the cable). Consequently, a chemical solution is more likely to enter the functioning section through the interface. The inventors further found out that, when the thermoplastic elastomer content is less than 10 parts by weight, flexibility of the polybutylene terephthalate resin composition is lowered.

That is, the inventor found that only the resin composition which contains the thermoplastic elastomer by 10 parts by weight to 40 parts by weight with respect to 100 parts by weight of polybutylene terephthalate resin can achieve satisfactory flexibility, oil resistance of the material itself, and a property of preventing a chemical solution from entering the functioning section. According to the configuration, therefore, it is possible to provide the electronic device which satisfies all flexibility, oil resistance, and strong coherence at the interface between different materials. Moreover, the outer layer of the cable is covered by the predetermined length or longer. This makes it possible to securely prevent a chemical solution from penetrating through the interface between the jacket and the cable. It is therefore possible to provide the oil resistant electronic device which (i) has high reliability and (ii) hardly causes defective connection even when the oil resistant electronic device is used for a long time under severe environment in which the oil resistant electronic device is frequently in contact with a machine oil and the like.

A method for producing an oil resistant electronic device of one or more embodiments of the present invention includes the step of: covering, with a polybutylene terephthalate resin composition, (i) an entire cross section of at least one end of a cable and (ii) an outer layer of the cable by 2.5 mm or more from the at least one end in a lengthwise direction, the polybutylene terephthalate resin composition containing a thermoplastic elastomer by 10 parts by weight to 40 parts by weight with respect to 100 parts by weight of a polybutylene terephthalate resin.

According to the configuration, the cross section of the cable and the outer layer of the cable accounting for a predetermined ratio or more are covered with the polybutylene terephthalate resin composition which is excellent in oil resistance and flexibility. This makes it possible to produce the electronic device which (i) has high coherence between the cable and the jacket at their interface and (ii) is excellent in oil resistance and flexibility.

The oil resistant electronic device of one or more embodiments of the present invention includes: a functioning section which has a function of the oil resistant electronic device; a cable via which an electric signal is transmitted to the functioning section; and a jacket which covers the cable, the jacket being made of a polybutylene terephthalate resin composition containing a thermoplastic elastomer and a polybutylene terephthalate resin where the thermoplastic elastomer is contained by 10 parts by weight to 40 parts by weight with respect to 100 parts by weight of the polybutylene terephthalate resin, and the cable being covered with the jacket so that the jacket covers (i) an entire cross section of at least one end of the cable and (ii) an outer layer of the cable by 2.5 mm or more from the at least one end in a lengthwise direction. The resin composition is excellent in water resistance, oil resistance, and flexibility. Therefore, it is possible to provide an electronic device which can be used for a long time even under severe environment in which the electronic device frequently contacts with a chemical solution.

### BRIEF DESCRIPTION OF DRAWINGS

FIG. 1A illustrates a plan view of a main configuration of a connector which exemplifies an electronic device in accordance with one or more embodiments of the present invention.

FIG. 1B illustrates a cross sectional view taken along the line A-A as show in FIG. 1A of a main configuration of a connector which exemplifies an electronic device in accordance with one or more embodiments of the present invention.

FIG. 2A illustrates a plan view of a main configuration of a sensor in accordance with one or more embodiments of the present invention.

FIG. 2B illustrates a cross sectional view taken along the line B-B in FIG. 2A of a main configuration of a sensor in accordance with one or more embodiments of the present invention.

FIG. 3A is a schematic view illustrating a state where a cable is fixed before being bent of a schematic view illustrating a method for evaluating flexibility of an electronic device in accordance with one or more embodiments of the present invention.

FIG. 3B is a schematic view illustrating a state where the cable is bent as much as possible of a schematic view illustrating a method for evaluating flexibility of an electronic device in accordance with one or more embodiments of the present invention.

FIG. 4 is a schematic view illustrating a method for evaluating oil resistance by measuring a weight change ratio of an electronic device in accordance with one or more embodiments of the present invention.

FIG. 5A is a schematic view illustrating that a test piece, which is prepared by assembling a cable outer layer with a jacket together, is soaked in a test oil of a schematic view illustrating how oil resistance is evaluated by measuring a tensile strength change ratio of an electronic device in accordance with one or more embodiments of the present invention.

FIG. 5B is a schematic view illustrating how tensile strength of the test piece is measured before and after the test piece is soaked in the test oil of a schematic view illustrating how oil resistance is evaluated by measuring a tensile strength change ratio of an electronic device in accordance with one or more embodiments of the present invention.

### DETAILED DESCRIPTION

The following describes embodiments of the present invention. However, the present invention is not limited to the embodiments. Note that a range indicated by “A to B” in this specification means that the range is “A or more but B or less”.

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention.

(1. Oil Resistant Electronic Device)

(1-1. Polybutylene Terephthalate Resin)

An oil resistant electronic device of one or more embodiments of the present invention includes: a functioning section which has a function of the oil resistant electronic device; a cable via which an electric signal is transmitted to the functioning section; and a jacket which covers the cable, the jacket being made of a polybutylene terephthalate resin composition (hereinafter, sometimes referred to as “polybutylene terephthalate resin composition used in one or more embodiments of the present invention”) containing a thermoplastic elastomer and a polybutylene terephthalate resin where the thermoplastic elastomer is contained by 10 parts by weight to 40 parts by weight with respect to 100 parts by weight of the polybutylene terephthalate resin, and the cable being covered with the jacket so that the jacket covers (i) an entire cross section of at least one end of the cable and (ii) an outer layer of the cable by 2.5 mm or more from the at least one end in a lengthwise direction.

Note that the “oil resistant electronic device” in this specification indicates an electronic device which is determined to be practicable in view of a flexibility evaluation, an oil resistance evaluation, and an oil resistance evaluation in a product form, which are described in Examples later.

The polybutylene terephthalate (hereinafter, sometimes referred to as “PBT”) resin, which is contained in the polybutylene terephthalate resin composition used in one or more embodiments of the present invention, is a macromolecule having a configuration in which a terephthalic acid unit is ester-linked with a 1,4-butanediol unit where the terephthalic acid unit accounts for 50 mol % or more of a dicarboxylic acid unit and the 1,4-butanediol unit accounts for 50 mol % or more of a diol component (diol unit).

In other words, the PBT resin used in one or more embodiments of the present invention is a macromolecule having a configuration in which the dicarboxylic acid unit is ester-linked with the diol unit so that 50 mol % or more of the dicarboxylic acid unit is the terephthalic acid unit and 50 mol % or more of the diol unit is the 1,4-butanediol unit.

In a case where the amount of the terephthalic acid unit or the 1,4-butanediol unit is too small, e.g., less than 50 mol %, it sometimes happens that a crystallization rate of the PBT resin becomes slow, and therefore moldability of the resultant polybutylene terephthalate resin would be lowered. Therefore, according to one or more embodiments of the present invention, the ratio of the terephthalic acid unit to the total dicarboxylic acid unit is normally 70 mol % or more, and in one or more embodiments the ratio is 80 mol %, 95 mol %, or 98 mol % or more. Moreover, it is possible that the ratio of the 1,4-butanediol unit to the total diol unit is normally 70 mol % or more, and in one or more embodiments the ratio is 80 mol %, 95 mol %, or 98 mol % or more.

The PBT resin can contain other dicarboxylic acid component other than the terephthalic acid, provided that mol % or more of the dicarboxylic acid unit is the terephthalic acid unit. That is, the dicarboxylic acid unit can contain other dicarboxylic acid component, provided that 50 mol % or more of the dicarboxylic acid unit is the terephthalic acid unit.

Specifically, the other dicarboxylic acid component can be, for example, an aromatic dicarboxylic acid such as phthalic acid, isophthalic acid, 4,4′-diphenyldicarboxylic acid, 4,4′-diphenyl ether dicarboxylic acid, 4,4′-benzophenone dicarboxylic acid, 4,4′-diphenoxyethanedicarboxylic acid, 4,4′-diphenylsulfone dicarboxylic acid, or 2,6-naphthalene dicarboxylic acid; an alicyclic dicarboxylic acid such as 1,2-cyclohexanedicarboxylic acid, 1,3-cyclohexanedicarboxylic acid, or 1,4-cyclohexanedicarboxylic acid; or an aliphatic dicarboxylic acid such as malonic acid, succinic acid, glutaric acid, adipic acid, pimelic acid, suberic acid, azelaic acid, or sebacic acid; or the like.

The dicarboxylic acid component can be introduced into a polymer skeleton (i) by adding it in the form of a dicarboxylic acid or (ii) by adding a dicarboxylic acid derivative (such as a dicarboxylic acid ester or a dicarboxylic acid halide) as a raw material of the dicarboxylic acid component.

The PBT resin can contain other diol component other than the 1,4-butanediol, provided that 50 mol % or more of the diol component is the 1,4-butanediol unit. That is, the diol unit can contain other diol component, provided that 50 mol % or more of the diol unit is the 1,4-butanediol unit.

Specifically, the other diol component can be, for example, an aliphatic diol such as ethylene glycol, diethylene glycol, polyethylene glycol, 1,2-propanediol, 1,3-propanediol, polypropylene glycol, polytetramethylene glycol, dibutylene glycol, 1,5-pentanediol, neopentyl glycol, 1,6-hexanediol, or 1,8-octanediol; an alicyclic diol such as 1,2,-cyclohexanediol, 1,4-cyclohexanediol, 1,1-cyclohexanedimethylol, or 1,4-cyclohexanedimethylol; or an aromatic diol such as xylylene glycol, 4,4′-dihydroxybiphenyl, 2,2-bis(4-hydroxyphenyl)propane, or bis(4-hydroxyphenyl)sulfone; or the like.

Moreover, the PBT resin used in one or more embodiments of the present invention may be prepared by copolymerizing these units mentioned above further with a conventionally known arbitrary monomeric unit. Specifically, such a monomer component can be, for example, a hydroxycarboxylic acid such as lactic acid, glycolic acid, m-hydroxybenzoic acid, p-hydroxybenzoic acid, 6-hydroxy-2-naphthalenecarboxylic acid, or p-β-hydroxyethoxybenzoic acid; a monofunctional component such as alkoxy carboxylic acid, stearyl alcohol, benzyl alcohol, stearic acid, benzoic acid, t-butyl benzoic acid, benzoylbenzoic acid; a polyfunctional component, having three or more functional groups, such as tricarballylic acid, trimellitic acid, trimesic acid, pyromellitic acid, gallic acid, trimethylolethane, trimethylolpropane, glycerol, or pentaerythritol; or the like.

A method for producing the PBT resin is not limited to a particular one, and the PBT resin can therefore be produced by a conventionally known method with the use of a conventionally known catalyst. For example, the PBT resin may be produced by a method (direct polymerization method), in which dicarboxylic acid is used as a main material. Alternatively, the PBT resin may be produced by a method (ester interchange method), in which dicarboxylic acid dialkyl ester is used as a main material. Alternatively, the PBT resin can be a commercially available one.

The PBT resin is not particularly limited in terms of its weight-average molecular weight. However, it is possible that the weight-average molecular weight falls within a range from 20,000 to 80,000, and according to one or more embodiments of the invention, the weight-average molecular weight falls within a range from 40,000 to 60,000, because a molded product is required to have impact resistance.

The PBT resin can contain a component such as a bromine compound such as pentabromodiphenyl ether, octabromodiphenyl ether, decabromodiphenyl ether, tetrabromobisphenol A, or hexabromocyclododecane; or an inorganic compound such as phosphate ester (such as triphenyl phosphate), antimony trioxide, antimony pentoxide, aluminium hydroxide, or magnesium hydroxide. Each of these materials is a flame retardant component with which the polybutylene terephthalate resin composition used in one or more embodiments of the present invention can be improved in terms of flame retardancy. It is possible that the flame retardant component is contained in the polybutylene terephthalate resin composition by 5 parts by weight to 40 parts by weight, and according to one or more embodiments, 15 parts by weight to 25 parts by weight, with respect to the total (100 parts by weight) of a polybutylene terephthalate resin and a thermoplastic elastomer which constitute the polybutylene terephthalate resin composition used in one or more embodiments of the present invention.

The PBT resin may contain an inorganic titanium compound such as titanium oxide or titanium tetrachloride; a metallic additive such as (i) titanium alcoholate such as tetramethyl titanate, tetraisopropyl titanate, or tetrabutyl titanate, or (ii) titanium phenolate such as tetraphenyl titanate; or a compound of various kinds such as (a) a group metal compound such as lithium, sodium, potassium, rubidium, or cesium, (b) a group 2 metal compound such as beryllium, magnesium, calcium, strontium, or barium, (c) a hydroxide, an oxide, an alkoxide or an organic acid salt (such as acetate, phosphate, or carbonate) of these group 1 and group 2 metals.

Each of the above compounds of various kinds is a metal compound which is possibly transferred, as a component of trace amount, from a catalyst into the polybutylene terephthalate resin composition used in one or more embodiments of the present invention during the production of the PBT resin. It is possible that the various compounds is contained in the polybutylene terephthalate resin composition by 3 ppm to 70 ppm, or possibly by 10 ppm to 40 ppm, with respect to the total weight of the polybutylene terephthalate resin and the thermoplastic elastomer which constitute the polybutylene terephthalate resin composition used in one or more embodiments of the present invention. Provided that the contained amount of the various compounds falls within the range above described, properties of the polybutylene terephthalate resin composition used in one or more embodiments of the present invention are not affected by the various compounds.

The PBT resin can further contain tin or a tin compound such as dibutyltin oxide, methylphenyltin oxide, tetraethyltin, hexaethylditin oxide, cyclohexahexyl ditin oxide, didodecyltin oxide, triethyltin hydroxide, triphenyltin hydro-oxide, triisobutyltin acetate, dibutyltin diacetate, diphenyltin dilaurate, monobutyltin trichloride, tributyltin chloride, dibutyltin sulfide, butylhydroxytin oxide, methylstannonic acid, ethylstannonic acid, or butylstannonic acid.

The components exemplified above (hereinafter, referred to as “tin components”) are possibly generated during the synthesis of the PBT resin, and remain in the PBT resin. It is possible that a contained amount of the tin component in the polybutylene terephthalate resin composition used in one or more embodiments of the present invention is suppressed as much as possible. Specifically, it is possible that the tin component is contained in the polybutylene terephthalate resin composition by at most 200 ppm or less, or 100 ppm or less, with respect to the total weight of the polybutylene terephthalate resin and the thermoplastic elastomer which constitute the polybutylene terephthalate resin composition. Provided that the contained amount of the tin component falls within the range above described, properties of the polybutylene terephthalate resin composition used in one or more embodiments of the present invention are not affected by the tin component.

(1-2. Thermoplastic Elastomer)

The thermoplastic elastomer, which is a constituent of the polybutylene terephthalate resin composition used in one or more embodiments of the present invention, provides the polybutylene terephthalate resin composition with flexibility.

The thermoplastic elastomer is not limited to a particular one. The thermoplastic elastomer can be, for example, a polyester-ether thermoplastic polyester elastomer; natural rubber; a polymer or a copolymer of diene monomers such as butadiene, isoprene, pentadiene, hexadiene, heptadiene, or chloroprene; a butylene-ethylene-styrene copolymer; an ethylene-vinyl acetate copolymer; silicone rubber such as organopolysiloxane; polyurethane; soft polyvinyl chloride; styrene-butadiene rubber; an olefinic elastomer (TPO); a styrene elastomer (TPS); a urethane elastomer (TPU); an amide elastomer (TPA); an ester elastomer (TPEE); or a vinyl chloride elastomer (TPVC).

In one or more embodiments of the present invention, it is possible to use the polyester-ether thermoplastic polyester elastomer (hereinafter, referred to as “thermoplastic elastomer A”) out of the thermoplastic elastomers above exemplified. The thermoplastic elastomer A is a polyester-ether type block copolymer made up of (i) an aromatic polyester block which is a hard segment and (ii) an aliphatic polyether block which is a soft segment. Note that the aliphatic polyether block mainly contains polyalkylene ether glycol.

The aromatic polyester block contains, as monomeric units, (i) a dicarboxylic acid or ester-forming derivative thereof and (ii) a low-molecular-weight glycol or ester-forming derivative thereof.

The dicarboxylic acid or ester-forming derivative thereof which constitutes the aromatic polyester block is not limited to a particular one. The dicarboxylic acid or ester-forming derivative thereof can be (i) an aromatic dicarboxylic acid such as phthalic acid, terephthalic acid, isophthalic acid, 1,4- or 2,6-naphthalene dicarboxylic acid, 4,4′-diphenyldicarboxylic acid, 4,4′-diphenyl ether dicarboxylic acid, or 4,4′-diphenylsulfone dicarboxylic acid or (ii) an alkyl ester of these.

The low-molecular-weight glycol or ester-forming derivative thereof is not limited to a particular one. The low-molecular-weight glycol or ester-forming derivative thereof can be, for example, an aliphatic diol such as ethylene glycol, propylene glycol, trimethylene glycol, tetramethylene glycol, or hexamethylene glycol; an alicyclic diol such as 1,4-cyclohexanediol or 1,4-cyclohexanedimethanol; or an aromatic diol such as 4,4′-dihydroxybiphenyl or 2,2-bis(4′-β-hydroxyethoxyphenyl) propane. The thermoplastic elastomer A can contain one (1) type of or two types or more of the dicarboxylic acid or ester-forming derivative thereof. Similarly, the thermoplastic elastomer A can contain one (1) type of or two types or more of the low-molecular-weight glycol or ester-forming derivative thereof.

As the aromatic polyester block, an aromatic polyester block made up of the terephthalic acid and the tetramethylene glycol out of those exemplified above is possible in view of properties such as compatibility and heat resistance. Specifically, it is possible that the aromatic polyester block mainly contains terephthalic acid and tetramethylene glycol so that (i) 50 mol % or more, or 70 mol % or more of the dicarboxylic acid or ester-forming derivative thereof consists of the terephthalic acid and (ii) 50 mol % or more, or 70 mol % or more of the low-molecular-weight glycol or ester-forming derivative thereof consists of the tetramethylene glycol.

Specifically, the polyalkylene ether glycol, which is a main component of the aliphatic polyether block, can be, for example, a C₁-C₈ polyalkylene ether glycol, possibly a C₂-C₆ polyalkylene ether glycol, such as polyethylene glycol, polypropylene glycol, polytrimethylene ether glycol, polytetramethylene ether glycol, polyhexamethylene ether glycol, a block or a random copolymer of ethylene oxide and propylene oxide, or a block or a random copolymer of ethylene oxide and tetrahydrofuran. In particular, the polytetramethylene ether glycol is possible.

The aliphatic polyether block mainly contains polyalkylene ether glycol. Specifically, it is possible that a contained amount of the polyalkylene ether glycol in the aliphatic polyether block is 50 mol % or more, 70 mol % or more, or possibly 90 mol % or more.

It is possible that the polyalkylene ether glycol constituting the aliphatic polyether block has a weight-average molecular weight falling within a range from 400 to 6000, 500 to 4000, or possibly 600 to 3000. Moreover, it is possible that an amount of polyalkylene ether glycol unit contained in the entire thermoplastic elastomer A falls within a range from 5% by weight to 80% by weight, 8% by weight to 70% by weight, or possibly 10% by weight to 60% by weight.

In a case where the polyalkylene ether glycol unit accounts for less than 5% by weight of the entire thermoplastic elastomer A used in one or more embodiments of the present invention, it is not possible to sufficiently improve impact resistance of the polybutylene terephthalate resin composition used in one or more embodiments of the present invention. Whereas, in a case where the polyalkylene ether glycol unit accounts for more than 80% by weight of the entire thermoplastic elastomer A, affinity for the PBT resin is decreased, and therefore a mechanical characteristic is deteriorated.

The thermoplastic elastomer A can be produced by an arbitrary method. In general, the thermoplastic elastomer A can be produced by the following method: That is, a dicarboxylic acid or ester-forming derivative thereof is reacted with a low-molecular-weight glycol or ester-forming derivative thereof, thereby obtaining a polyester oligomer. Then, the polyester oligomer is mixed with a predetermined amount of a polyalkylene ether glycol having a predetermined molecular weight. Then, the polyester oligomer and the polyalkylene ether glycol are copolymerized, if necessary, in the presence of a tin catalyst etc.

(1-3. Polybutylene Terephthalate Resin Composition)

A polybutylene terephthalate resin composition used in an electronic device of one or more embodiments of the present invention contains 10 parts by weight to 40 parts by weight of the thermoplastic elastomer with respect to 100 parts by weight of the PBT resin.

An electronic device such as a connector or a sensor, which has a configuration in which a functioning section which has a function of the electronic device is provided at the end of a cable, is used under a severe condition (e.g., in an automotive factory) in which the electronic device is exposed to a chemical solution such as a wax, a machine oil, and a cleaning fluid for a long time under hot and humid environment. In general, the electronic device has a configuration in which a cable is at least partially covered with a jacket so that the cable is protected. However, as described above, it has not been possible to effectively prevent the chemical solution from penetrating through an interface between the cable and the jacket.

The PBT resin is excellent in properties such as mechanical property and electrical property but has low impact strength. In general, therefore, thermoplastic elastomer is added to the PBT resin so that the impact strength is improved. Patent Literature 3 discloses that a PBT resin composition, which is prepared by adding a predetermined amount of the thermoplastic elastomer A to a predetermined PBT resin, is excellent in impact strength, tensile extensibility, and hydrolysis resistance. The “hydrolysis resistance” in Patent Literature 3 is assumed to be resistance to deterioration caused by steam under a high temperature condition.

On the other hand, in the electronic device such as a connector, it is necessary to prevent (i) the chemical solution from entering the functioning section through a material itself of the cable or the jacket and (ii) the chemical solution, which flows along the cable, from entering the functioning section through the interface between the jacket and the cable.

The chemical solution which possibly enters the functioning section in a factory, etc. encompasses a hydrophilic solution (such as a cleaning fluid or steam) and a hydrophobic solution (such as a machine oil or a wax). The jacket, which protects the cable, is generally made of resin, and therefore has a hydrophobic property. Accordingly, the jacket has an affinity for a hydrophobic chemical solution rather than for a hydrophilic chemical solution. In other words, the hydrophobic chemical solution more likely to enter the functioning section through the interface between the jacket and the cable, rather than the hydrophilic chemical solution does. Therefore, a resin composition having water resistance does not necessarily have sufficient oil resistance.

For the reasons above, the resin composition of Patent Literature 3 having hydrolysis resistance (water resistance) does not necessarily have oil resistance enough to prevent the hydrophobic chemical solution from entering the functioning section through the interface between the jacket and the cable. That is, Patent Literature 3 is completely silent about oil resistance. On the other hand, if the resin composition has excellent oil resistance, the resin composition would have also sufficient water resistance because the jacket is made of a hydrophobic material.

In order to prevent the chemical solution from penetrating through the interface between the jacket and the cable, it may be effective to improve coherence at the interface between the jacket and the cable. The inventors of the present invention found that the coherence can be improved by reducing the thermoplastic elastomer content in the PBT resin composition.

However, it was also found that, in a case where the thermoplastic elastomer content is small, the PBT resin has poor flexibility, and therefore a breakage in a cable easily occurs when the PBT resin is used as an electronic device. Whereas, in a case where the thermoplastic elastomer content is large, aging of the PBT resin composition easily proceeds, thereby making it easy for the chemical solution to penetrate through the PBT resin composition. Further, the coherence is decreased, and therefore it is not possible to sufficiently prevent the chemical solution from penetrating through the interface between the jacket and the cable.

In view of this, the inventors of the present invention diligently studied about such a thermoplastic elastomer content in the PBT resin composition that can provide improved impact strength and sufficient flexibility to the PBT resin thereof and, at the same time, sufficiently preventing a chemical solution from penetrating through the resin composition itself and through an interface between a jacket and a cable in a case where the jacket is made of the PBT resin composition. As a result, the inventors of the present invention found that arranging such that the thermoplastic elastomer is contained in the polybutylene terephthalate resin by 10 parts by weight to 40 parts by weight with respect to 100 parts by weight of the polybutylene terephthalate resin may provide the above discussed attributes.

Note that, according to one or more embodiments of the present invention, the thermoplastic elastomer is used for the purpose of providing the jacket with flexibility. This purpose can be similarly attained by using another elastomer instead of the thermoplastic elastomer. Therefore, the thermoplastic elastomer used in one or more embodiments of the present invention is not limited to the thermoplastic elastomer A.

It is possible that the thermoplastic elastomer is contained in 100 parts by weight of the polybutylene terephthalate resin by 10 parts by weight to 40 parts by weight, or 10 parts by weight to 25 parts by weight. It is not recommended to set the contained amount to smaller than 10 parts by weight because, with such a contained amount, impact strength of the polybutylene terephthalate resin composition cannot be improved, and accordingly flexibility of the polybutylene terephthalate resin composition is deteriorated.

In a case where the thermoplastic elastomer content with respect to 100 parts by weight of the polybutylene terephthalate resin is larger than 40 parts by weight, oil resistance of the polybutylene terephthalate resin composition is decreased because oil resistance of the thermoplastic elastomer is not high. Accordingly, in a case where the jacket is made of the polybutylene terephthalate resin composition having such thermoplastic elastomer content, it becomes difficult to sufficiently prevent the chemical solution from penetrating through the resin composition itself and through the interface between the jacket and the cable. Therefore, such thermoplastic elastomer content (greater than 40 parts by weight) is not recommended.

In a case where the polybutylene terephthalate resin contains the flame retardant component, the compound of various kinds, or tin compound, the wording “100 parts by weight of the polybutylene terephthalate resin” indicates a used amount of the polybutylene terephthalate resin other than such components. That is, 10 parts by weight to 40 parts by weight of the thermoplastic elastomer is mixed with 100 parts by weight of the polybutylene terephthalate resin other than such components.

A method for producing the polybutylene terephthalate resin composition used in one or more embodiments of the present invention is not limited to a particular one, and a conventionally known method can therefore be used. A polybutylene terephthalate resin composition can be produced by mixing and dispersing 10 parts by weight to 40 parts by weight of a thermoplastic elastomer with respect to 100 parts by weight of a polybutylene terephthalate resin by the use of, for example, a twin-screwed kneading machine. A form of the resin composition is not limited to a particular one. It is therefore possible to appropriately determine, depending on usage, a form such as a pellet form, a powder form, a slurry form, or a liquid form, with the use of a conventionally known method.

(1-4. Jacket)

The jacket (cable covering jacket) used in the electronic device of one or more embodiments of the present invention is made by molding the polybutylene terephthalate resin composition. Such a jacket is used to protect the cable by covering the cable of an electronic device such as a connector or a sensor in which a functioning section such as a connector body or a sensor body is provide at an end of the cable.

The cable covering jacket can be obtained by molding the polybutylene terephthalate resin composition into a shape with the use of a general resin molding method such as an insert molding, an extrusion molding, a compression molding, or a blow molding.

The cable covering jacket can be produced independently or as a part of a constituent member of the electronic device. In a case where the cable covering jacket is produced as a part of a constituent member of the electronic device, it is possible to employ an insert molding in which a cable and an electronic device body are provided in a mold, and then the polybutylene terephthalate resin composition is introduced in the mold so that the cable is covered with the polybutylene terephthalate resin composition. This makes it possible to obtain the jacket not independently but as a part of the electronic device which part covers the cable in advance.

It is possible that the cable covering jacket is produced as a part of a constituent member of the electronic device in order to secure sufficient coherence at the interface between the cable covering jacket and the cable. However, one or more embodiments of the present invention is not limited to this. Even in a case where the cable covering jacket is produced independently from the electronic device, it is possible to firmly cohere the cable covering jacket with the cable by, for example, (i) molding the cable covering jacket in a shape which fits the cable, (ii) fitting the cable with the cable covering jacket, and then (iii) heating the interface between the cable covering jacket and the cable.

Note that the “interface between the jacket and the cable” in this specification indicates an interface shared by both the jacket and cable which is covered with the jacket. Moreover, the term “covered” means that a cross section or an outer layer of a constituent member is partially or wholly covered.

The cable covering jacket is made by molding the polybutylene terephthalate resin composition. Therefore, the cable covering jacket has flexibility and oil resistance by itself and can firmly cohere to the cable. Therefore, in a case where the cable covering jacket is used to cover a cable of an electronic device such as a connector or a sensor which is to be exposed to a chemical solution for a long time, it is possible to sufficiently prevent the chemical solution from entering the functioning section.

(1-5. Covering Cable with Jacket)

The “functioning section which has a function of the electronic device” indicates a section which is essential for fulfilling the function of the electronic device. Such a function section can be, for example, (i) a connector body having a terminal or (ii) a sensor body in which a substrate is provided. In view of this, it is necessary to prevent a chemical solution from entering the functioning section in order for the functioning section to sufficiently fulfill its function.

The cable can be a conventionally known cable, provided that an electric signal can be transmitted via the cable. Such a cable can be, for example, a cable containing inside a lead wire made of a material such as copper. The electronic device is generally configured such that the lead wire penetrates inside the jacket so as to be connected with a functioning section such as a connector body so that an electric signal can be transmitted to the functioning section via the lead wire. In view of this, in a case where the jacket has low flexibility and is easily broken, it is possible that a chemical solution penetrates through the jacket itself or through the interface between the jacket and the cable, and this causes a breakage in the wire. According to the electronic device of one or more embodiments of the present invention, the jacket is made of the polybutylene terephthalate resin composition which is excellent in flexibility and oil resistance. This makes it possible to prevent a damage to the lead wire. Note that the number of the lead wire is not limited in particular.

A material which constitutes the outer layer of the cable is not limited to a particular one, and a conventionally known material can therefore be used. For example, a thermoplastic resin material such as polyethylene resin, polyvinyl chloride resin, polyester resin, polyamide resin, PE elastomer resin, PVC elastomer resin, or polyurethane resin can be used. In particular, the polyvinyl chloride resin and the polyurethane resin are possible.

The electronic device of one or more embodiments of the present invention is not limited to a particular one. However, it is possible that the electronic device is exposed to a chemical solution for a long time. Such an electronic device can be, for example, a connector, a sensor, or a switch. Moreover, the sensor is not limited to a particular one. The sensor can be, for example, a proximity sensor or a photoelectronic sensor.

The jacket which covers the cable is above described in the section (1-4.). It is necessary that the jacket at least partially cover the cable, as described later. Moreover, the jacket may partially cover the functioning section.

Note that a chemical solution possibly penetrates also through the interface between the jacket and the functioning section. Under practical use, however, the functioning section is usually protected by a member such as a metallic part provided on the functioning section. On the other hand, in general, the interface between the jacket and the cable is not protected. Therefore, the chemical solution which penetrates through the interface between the jacket and the functioning section is less likely to affect the functioning section, as compared to the chemical solution which penetrates through the interface between the jacket and the cable. In view of this, the jacket does not necessarily need to cover the functioning section.

The description “the cable is covered with the jacket so that the jacket covers an entire cross section of at least one end of the cable” means that, because the cable has at least two ends, an entire cross section of at least one of the at least two ends needs to be covered with the jacket. The other of the at least two ends, of course, may also be covered.

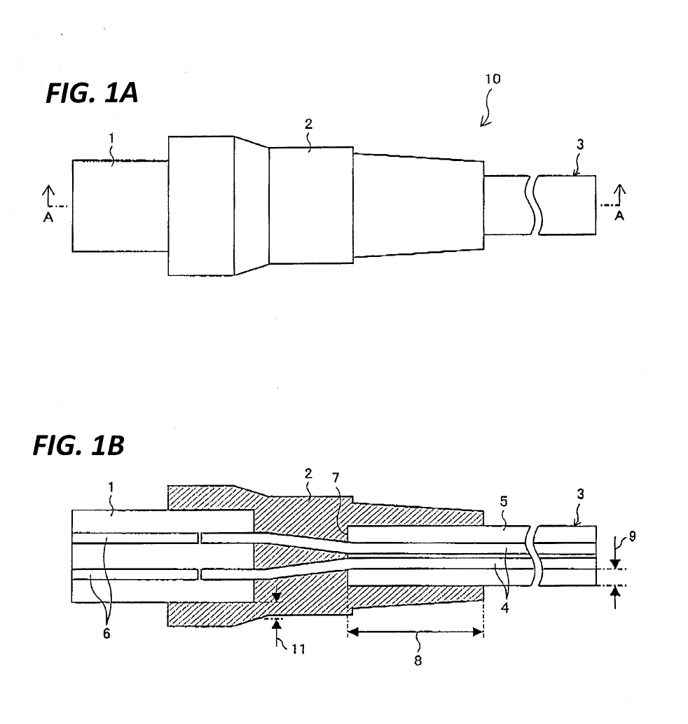

FIGS. 1A and 1B illustrate a main configuration of a connector 10, which exemplifies the electronic device of one or more embodiments of the present invention. FIG. 1A is a plan view illustrating the connector 10. FIG. 1B is a cross sectional view taken along the line A-A of FIG. 1A.

The connector 10 of one or more embodiments includes a cable 3, a connector body (functioning section) 1 connected with the cable 3, and a jacket 2 which covers the cable 3 and the connector body (functioning section) 1 (see FIG. 1B). The cable 3 includes two lead wires 4 and a cable outer layer 5 which covers the lead wires 4. The connector 10 is configured such that the two lead wires 4 are provided in the cable 3 so as to connect the cable 3 with the connector body (functioning section) 1. The connector body (functioning section) 1 has terminals 6.

The cable 3 fits in the jacket 2 so that (i) an entire cross section 7 of one (1) end of the cable 3 is covered with the jacket 2 and (ii) a covered section 8 of the outer layer is covered with the jacket 2 (see FIG. 1B).

The cable 3 is covered with the jacket 2 so that the outer layer of the cable 3 is covered with the jacket 2 by 2.5 mm or more from the end of the cable 3 in a lengthwise direction. The outer layer of the cable 3 which is covered with the jacket 2 by 2.5 mm or more from the end of the cable 3 in a lengthwise direction of the cable 3 is exemplified by the covered section 8 shown in FIG. 1B, and is defined as an area between (i) a periphery of a cross section of the cable end covered with the jacket (i.e., a periphery of the cross section 7 of the cable end in FIG. 1B) and (ii) a point apart from the periphery by 2.5 mm or more in the lengthwise direction.

In a case where a distance by which the outer layer is covered (hereinafter, simply referred to as “covered distance”, which corresponds to a length of the covered section 8 in FIG. 1B) is shorter than 2.5 mm from the end of the cable in the lengthwise direction, the jacket is easily broken when a bending angle of the cable becomes larger and therefore stress is concentrated on the interface. It is therefore impossible to sufficiently prevent the chemical solution from penetrating through the interface between the jacket and the cable.

On the other hand, according to the electronic device of one or more embodiments of the present invention, (i) the jacket is made of the polybutylene terephthalate resin which contains thermoplastic elastomer by 10 parts by weight to 40 parts by weight with respect to 100 parts by weight of polybutylene terephthalate resin and (ii) the covered distance is 2.5 mm or more in the lengthwise direction from the end of the cable. This makes it possible to sufficiently prevent the chemical solution from penetrating through the interface between the jacket and the cable.

A method for covering the cable with the jacket is not limited to a particular one. It is therefore possible to employ, for example, an insert molding in which a cable and an electronic device body are provided in a mold, and then the polybutylene terephthalate resin composition is poured in the mold so that the cable is covered with the polybutylene terephthalate resin composition. In order to secure the covered distance of 2.5 mm or more, the jacket should be molded such that the jacket is disposed in the mold so that the covered distance from the end of the cable is secured by 2.5 mm or more in the lengthwise direction.

Note that an upper limit of the covered distance is not limited to a particular one. However, it is possible that the covered distance is 20 mm or shorter in order to secure flexibility.

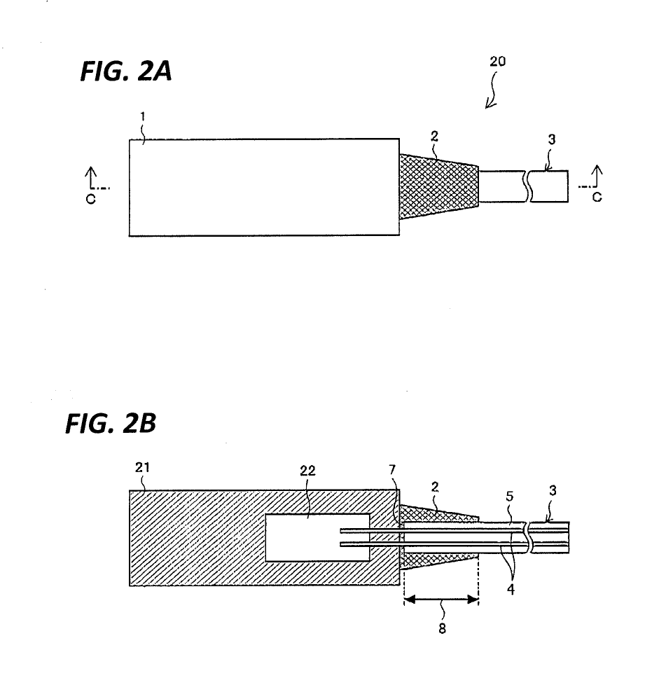

FIGS. 2A and 2B illustrate a main configuration of a sensor, which exemplifies the electronic device of one or more embodiments of the present invention. FIG. 2A is a plan view, and FIG. 2B is a cross sectional view taken along the line B-B of FIG. 2A. In FIGS. 2A and 2B, the same reference numerals are given to constituent members which are identical to those shown in FIGS. 1A and 1B. According to a sensor 20, a sensor body (functioning section) 21 is provided with a substrate 22, and lead wires 4 are connected with the substrate 22. The sensor 20 is also configured such that (i) a jacket 2 is made of the polybutylene terephthalate resin composition and (ii) the covered distance of the covered section 8 is 2.5 mm or more from the end of the cable in the lengthwise direction. This makes it possible to prevent a chemical solution from penetrating through the interface between the jacket 2 and the cable 3.

As described above, an oil resistant electronic device of one or more embodiments of the present invention includes: a functioning section which has a function of the oil resistant electronic device; a cable via which an electric signal is transmitted to the functioning section; and a jacket which covers the cable, the jacket being made of a polybutylene terephthalate resin composition containing a thermoplastic elastomer and a polybutylene terephthalate resin where the thermoplastic elastomer is contained by 10 parts by weight to 40 parts by weight with respect to 100 parts by weight of the polybutylene terephthalate resin, and the cable being covered with the jacket so that the jacket covers (i) an entire cross section of at least one end of the cable and (ii) an outer layer of the cable by 2.5 mm or more from the at least one end in a lengthwise direction.

In the oil resistant electronic device of one or more embodiments of the present invention, it is possible that the thermoplastic elastomer is a polyester-ether thermoplastic polyester elastomer.

The polyester-ether thermoplastic polyester elastomer has excellent flexibility, and accordingly the polybutylene terephthalate resin composition which contains a predetermined amount of the polyester-ether thermoplastic polyester elastomer can have moderate flexibility. This makes it possible to achieve well-balanced (i) flexibility of the oil resistant electronic device, (ii) oil resistance of the material itself, and (iii) a property of preventing a chemical solution from entering the functioning section.

Moreover, it is possible that the electronic device of one or more embodiments of the present invention is a connector or a sensor.

A connector or a sensor is an electronic device which (i) has a functioning section, in which a terminal or a substrate is fixed, and a cable and (ii) is often used under severe condition (e.g., in an automotive factory) in which the electronic device is exposed to a machine oil, a chemical solution, and the like for a long time under hot and humid environment. The electronic device of one or more embodiments of the present invention can sufficiently prevent a chemical solution from penetrating through the interface between the jacket and the cable. According to the configuration, it is possible to provide a connector or a sensor which (i) is excellent in water resistance and oil resistance and (ii) secures connection reliability of a terminal and a substrate for a long period of time.

(2. Method for Producing Oil resistant Electronic Device)

A method for producing an oil resistant electronic device of one or more embodiments of the present invention includes the step of: covering, with a polybutylene terephthalate resin composition, (i) an entire cross section of at least one end of a cable and (ii) an outer layer of the cable by 2.5 mm or more from the at least one end in a lengthwise direction, the polybutylene terephthalate resin composition containing a thermoplastic elastomer by 10 parts by weight to 40 parts by weight with respect to 100 parts by weight of a polybutylene terephthalate resin.

The polybutylene terephthalate resin composition and the cable, which are described above, can be employed in one or more embodiments of the present invention.

The method for covering, with the resin composition, (i) the entire cross section of the at least one end of the cable and (ii) the outer layer by 2.5 mm or more from the end of the cable in the lengthwise direction is not limited to a particular one. For example, an insert molding can be employed in which the cable and the electronic device body are provided in a mold and then the polybutylene terephthalate resin composition is introduced in the mold so that the cable can be covered with the polybutylene terephthalate resin composition.

A molding temperature while the cable is being covered is not limited to a particular one. In a case where an insert molding is employed, it is possible that a nozzle temperature falls within a range between 245° C. and 255° C., a front barrel temperature falls within a range between 240° C. and 250° C., a rear barrel temperature falls within a range between 235° C. and 245° C., and a mold temperature falls within a range between 55° C. and 65° C.

The present invention is not limited to the embodiments, but can be altered by a skilled person in the art within the scope of the claims. An embodiment derived from a proper combination of technical means disclosed in respective different embodiments is also encompassed in the technical scope of the present invention.

### EXAMPLES

The following describes Examples of one or more embodiments of the present invention for further details of one or more embodiments of the present invention. However, the one or more embodiments of present invention are not limited to the Examples.

### Example 1

With the use of a twin-screwed kneading machine, 10 parts by weight of a polyester-ether thermoplastic polyester elastomer resin component and 100 parts by weight of a polybutylene terephthalate resin (manufactured by Mitsubishi Engineering-Plastics Corporation, Novaduran 5010N6, weight-average molecular weight: 50,000) were mixed and dispersed. After the mixing and dispersing, the mixture was pelletized with the use of a pelletizer so that resin pellets for injection molding were prepared.

Note that the polyester type thermoplastic elastomer resin component which was used was obtained by copolymerizing polybutylene terephthalate (serving as a hard segment) with polytetramethylene ether glycol (serving as a soft segment) by a standard method known in the art. Specifically, the thermoplastic elastomer polyester resin component was obtained by the following method: That is, a terephthalic acid ester derivative was caused to react with butylene glycol to form a polyester oligomer, and then the polyester oligomer is mixed with 10% by weight of a polytetramethylene ether glycol derivative so that an elastomer resin was obtained by a copolymerization reaction of the polyester oligomer and the polytetramethylene ether glycol derivative. Note that, in the copolymerization reaction, tin catalyst or the like was used as appropriate.

The pellets were evaluated in view of flexibility and oil resistance with the use of the following evaluation methods (A through C).

### [Evaluation of Flexibility and Oil Resistance]

### [A. Evaluation of Flexibility (Evaluation in Product Form)]

With the use of a vertical injection molder ST10 (manufactured by Nissei Plastic Industrial Co., Ltd.), a connector was produced by the following method with the use of a resin composition obtained in each of Examples and Comparative Examples. First, a cable (φ 6 mm) made of vinyl chloride and a harness (φ 8 mm) made of PBT were provided in a mold, and then the cable and the harness were covered with the resin composition by an insert molding to produce, from the resin composition, a jacket covering the cable and the harness. A covered distance by which the jacket is in contact with an outer layer of the cable was set to 10 mm. Molding temperatures were set so that a nozzle temperature was 245° C., a front barrel temperature was 240° C., a rear barrel temperature was 230° C., and a mold temperature was 60° C.

Flexibility of the connector was evaluated with the use of an Autograph (AGS20kNG manufactured by Shimadzu Corporation) by the following testing method.

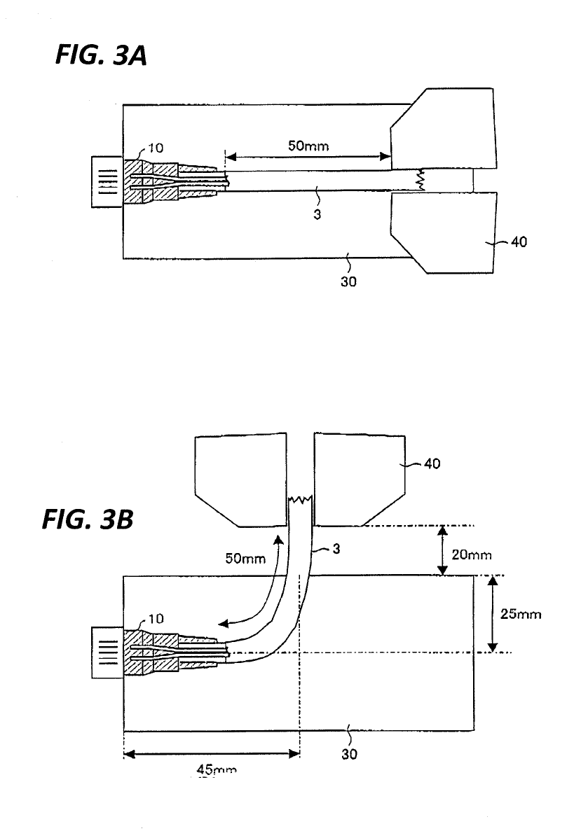

FIGS. 3A and 3B show a schematic view illustrating a method for evaluating flexibility of the electronic device in accordance with one or more embodiments of the present invention. Specifically, FIG. 3A is a schematic view illustrating a state where a cable is fixed before being bent. FIG. 3B is a schematic view illustrating a state where the cable is bent as much as possible. Note that, in FIGS. 3A and 3B, the same reference numerals are given to constituent members which are identical to those shown in FIGS. 1A and 1B.

First, a jacket 2 of a connector 10 was fixed by a screw-type planar gripper 30, and a cable was fixed by a wedge-shaped gripper 40 at a position 50 mm (movable cable length) apart from a cable-side end of the jacket (see FIG. 3A). Then, the end of the cable, fixed by the wedge-shaped gripper 40, was pulled up at a pulling rate of 10 mm/min (see FIG. 3B).

Note that the connector 10 was set in the screw-type planar gripper 30 so that the center of the connector 10 was centrally located in the screw-type planar gripper 30, i.e., located 2.5 mm apart from both upper and lower edges of the screw-type planar gripper 30 (see FIG. 3B). Moreover, the wedge-shaped gripper 40 was set so that a distance between the upper edge of the screw-type planar gripper 30 and a lower edge of the wedge-shaped gripper 40 would become 20 mm when the cable was maximally pulled up.

In a case where the connector 10 is actually used, one end of the cable would be moved while the other end is being fixed. In such a case, external force would be exerted on a connection section between the jacket 2 and the cable 3 at the risk of breaking the resin of the jacket 2 by the stress concentration. In view of this, each material of the connector 10 needs to maintain its shape without being broken even when the cable is maximally bent.

According to the test, how much moved amount of the end of the cable was necessary to break the jacket 2 was measured. According to the test, the movable cable length was set to 50 mm, and a movable rate was a ratio of a moved distance of the end of the cable to the movable cable length. For example, in a case where the end of the cable is moved by 10 mm, the movable rate is 20%. According to the evaluation method, a resin composition which was used as a jacket broken at a movable rate of 20% or lower was determined to be “Poor: impracticable”.

### [B. Evaluation of Oil Resistance (Evaluation on Test Piece)]

### [B-1. Evaluation of Oil Resistance of Resin]

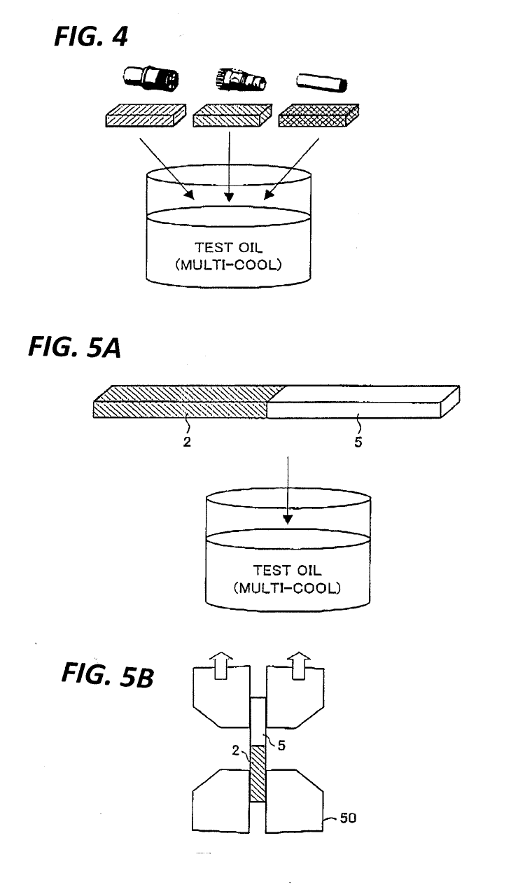

A strip test piece (79.6×9.3×3.2 mm) was made, with the use of an injection molder (Robo-shot α30B, manufactured by FANUC Corporation), from the resin pellets obtained in each of Examples and Comparative Examples. Molding temperatures were set so that a nozzle temperature was 245° C., a front barrel temperature was 240° C., a rear barrel temperature was 230° C., and a mold temperature was 60° C. An aqueous solution, in which a machine oil (Multi-Cool CSF9000, manufactured by KYODO YUSHI Co., Ltd.) was diluted 20-fold with tap water, was heated up to 50° C., and the strip test piece was soaked in the aqueous solution for 240 hours. FIG. 4 is a schematic view illustrating a method for evaluating oil resistance by measuring a ratio of weight change of the resin pellet. A weight change ratio X was obtained by measuring a weight of the strip test piece before and after the strip test piece was soaked in the aqueous solution.

The oil resistance was evaluated based on an evaluation criterion in which a weight change ratio X which was 2.0% or lower was determined as “Good” (practicable), whereas a weight change ratio X which was higher than 2.0% was determined as “Poor” (impracticable).

The cable outer layer 5 was made of vinyl chloride whose weight change ratio X was 5% which was obtained by the same evaluation method as in B-1. According to a shape of the connector, a thickness (i.e., a distance 11 shown in FIGS. 1A and 1B) of the jacket 2 was half of a thickness (i.e., a distance 9 shown in FIGS. 1A and 1B) of the cable outer layer 5. In view of this, a required weight change ratio of the jacket 2 was assumed to be 2.5% or lower, or possibly 2.0% or lower, and therefore the weight change ratio 2.5% or lower, or possibly 2.0% or lower, was set to the evaluation criterion for determining whether or not the jacket 2 is practicable.

### [B-2. Oil Resistance of Interface]

A test piece was prepared by an insert molding in which a strip test piece (39.8×9.3×3.2 mm) of vinyl chloride which was used as the cable outer layer 5 was provided in a mold and then a resin composition obtained in each of Examples and Comparative Examples was insert-molded under a condition in which a nozzle temperature was 245° C., a front barrel temperature was 240° C., a rear barrel temperature was 230° C., and a mold temperature was 60° C. Then, as with the evaluation method of B-1, an aqueous solution, in which a machine oil (Multi-Cool CSF9000) was diluted 20-fold with tap water, was heated up to 50° C., and the test piece was soaked in the aqueous solution for 240 hours. The oil resistance (a property of preventing a chemical solution from penetrating through interface) of an interface between a jacket and a cable was evaluated by measuring interface bonding strength of the test piece before and after the test piece was soaked in the aqueous solution.

The interface bonding strength was measured by stretching both ends of the test piece in opposite directions at a rate of 10 mm/min with the use of an autograph (AGS20kNG, manufactured by Shimadzu Corporation). FIGS. 5A and 5B are a schematic view illustrating a method for evaluating oil resistance by measuring a ratio of change of tensile strength of the electronic device in accordance with one or more embodiments of the present invention. FIG. 5A is a schematic view illustrating a case where a test piece, made by joining the jacket 2 and the cable outer layer 5 together, is soaked in a test oil. FIG. 5B is a schematic view illustrating a method for measuring tensile strength of the test piece before and after the test piece is soaked in the test oil. The oil resistance was evaluated based on an evaluation criterion in which (i) a tensile strength change ratio Y before and after the soakage, which ratio was equal to or lower than 5%, was determined to be “Good” (practicable), whereas (ii) a tensile strength change ratio Y which was higher than 5% was determined to be “Poor” (impracticable).

According to the evaluation method, it is possible that the tensile strength change ratio Y remains zero. In view of this, the threshold value was set based on whether or not an obtained tensile strength change ratio Y was acceptable as compared to the preference (zero). Specifically, in a case where an obtained tensile strength change ratio Y was higher than 5%, the test piece was evaluated as being impracticable.

### [C. Evaluation of Oil Resistance in Product Form]

With the use of a vertical injection molder ST10 (manufactured by Nissei Plastic Industrial Co., Ltd.), a connector was produced by the following method with the use of a resin composition obtained in each of Examples and Comparative Examples. First, a cable (φ 6 mm) made of vinyl chloride and a harness were provided in a mold, and then the cable and the harness were covered with the resin composition by an insert molding to produce, from the resin composition, a jacket covering the cable and the harness. A covered distance by which the jacket was in contact with an outer layer of the cable was set to 10 mm. Molding temperatures were set so that a nozzle temperature was 245° C., a front barrel temperature was 240° C., a rear barrel temperature was 230° C., and a mold temperature was 60° C. Then, an aqueous solution, in which a machine oil (Multi-Cool CSF9000) was diluted 20-fold with tap water, was heated up to 50° C., and the connector body and the cable were soaked in the aqueous solution for 200 hours in such a manner that 20 cm of the cable from a connection section (i.e., a cable end covered with the jacket) between the jacket and the cable was soaked. After the soakage, an insulation resistance test (JISC5442) was carried out. The oil resistance in the product form was evaluated based on an evaluation criterion in which (i) an insulation resistance Z which was equal to or higher than 120 MΩ was determined to be “Good” (practicable) whereas (ii) an insulation resistance Z which was lower than 120 MΩ was determined to be “Poor” (impracticable).

In a case where a polyvinyl chloride cable itself which was not covered with a jacket was subjected to the oil resistance test in the above described C., the insulation resistance Z was 120 MΩ. A connector or a sensor, in which a cable is covered with a jacket, is required to suppress deterioration in insulation resistance, as compared to the cable itself (without jacket). In view of this, a threshold value was set to 120 Mω.

Note that the resin compositions obtained in Examples through 5 and Comparative Examples 1 through 4, respectively, were evaluated similarly. The following Table 1 shows all the obtained evaluation results.

TABLE 1

| | | | | | A. | B. Oil resistance | | |
|---|---|---|---|---|---|---|---|---|
| | | | | | Flexibility | test | | C. Oil |
| | | | | | test | | Interface | resistance |
| | | | | | (moved | Material | (tensile | of product |
| | | | | Covered | distance | (weight | strength | (insulation |
| | PBT | Elastomer | Material of | distance | until | change | change | resistance |
| | component | component | cable | of cable | breakage) | ratio) | ratio) | after 200 h) |
| Example 1 | 100 | 10 | polyvinyl | 10 mm | Good | Good | Good | Good |
| | | | chloride | | (32%) | (0.8%) | ±0 | (160 MΩ) |
| Example 2 | 100 | 25 | polyvinyl | 10 mm | Good | Good | Good | Good |
| | | | chloride | | (40%) | (1.2%) | ±0 | (140 MΩ) |
| Example 3 | 100 | 40 | polyvinyl | 10 mm | Good | Good | Good | Good |
| | | | chloride | | (50%) | (1.5%) | ±0 | (130 MΩ) |
| Example 4 | 100 | 25 | polyvinyl | 2.5 mm | Good | Good | Good | Good |
| | | | chloride | | (40%) | (1.2%) | ±0 | (135 MΩ) |
| Example 5 | 100 | 25 | polyurethane | 10 mm | Good | Good | Good | Good |
| | | | | | (40%) | (1.2%) | ±0 | (3200 MΩ) |
| Comparative | 100 | 0 | polyvinyl | 10 mm | Poor | Good | Poor | Poor |
| Example 1 | | | chloride | | (14%) | (0.4%) | 55% down | (99 MΩ) |
| Comparative | 100 | 50 | polyvinyl | 10 mm | Good | Poor | Poor | Poor |
| Example 2 | | | chloride | | (60%) | (2.2%) | 13% down | (105 MΩ) |
| Comparative | 0 | 100 | polyvinyl | 10 mm | Good | Poor | Poor | Poor |
| Example 3 | | | chloride | | (Unbroken) | (3.5%) | 20% down | (99 MΩ) |
| Comparative | 100 | 25 | polyvinyl | 1 mm | Good | Good | Good | Poor |
| Example 4 | | | chloride | | (40%) | (1.2%) | ±0 | (45 MΩ) |
| Threshold | | | | | 20% (10 mm) | 2.0% | Within | 120 MΩ |
| value | | | | | | | 5% | |

A connector, in which a cable was covered with a resin obtained in Example 1, showed a movable rate of 32%, a weight change ratio of 0.8%, a tensile strength change ratio of 0%, and insulation resistance of 160 M. From the results, the resin obtained in Example 1 was evaluated as being practicable as a product in view of flexibility and oil resistance.

### Example 2

An evaluation was carried out under a condition basically identical to that of Example 1, except that the polyester-ether thermoplastic polyester elastomer resin component was used by 25 parts by weight with respect to 100 parts by weight of polybutylene terephthalate resin.

### Example 3

An evaluation was carried out under a condition basically identical to that of Example 1, except that the polyester-ether thermoplastic polyester elastomer resin component was used by 40 parts by weight with respect to 100 parts by weight of polybutylene terephthalate resin.

### Example 4

An evaluation was carried out under a condition basically identical to that of Example 2, except that the covered distance of the cable was changed to 2.5 mm.

### Example 5

An evaluation was carried out under a condition basically identical to that of Example 2, except that the material of the cable was changed to polyurethane.

### Comparative Example 1

An evaluation was carried out under a condition basically identical to that of Example 1, except that the polyester-ether thermoplastic polyester elastomer resin component was used by 0 parts by weight with respect to 100 parts by weight of polybutylene terephthalate resin.

### Comparative Example 2

An evaluation was carried out under a condition basically identical to that of Example 1, except that polyester-ether thermoplastic polyester elastomer resin component was used by 50 parts by weight with respect to 100 parts by weight of polybutylene terephthalate resin.

### Comparative Example 3

An evaluation was carried out under a condition basically identical to that of Example 1, except that the polybutylene terephthalate resin was used by 0 parts by weight with respect to 100 parts by weight of polyester-ether thermoplastic polyester elastomer resin component.

### Comparative Example 4

An evaluation was carried out under a condition basically identical to that of Example 2, except that the covered distance of the cable was changed to 1 mm.

The results of Examples and Comparative Examples showed that only a polybutylene terephthalate resin composition which contains 10 parts by weight to 40 parts by weight of the thermoplastic elastomer with respect to 100 parts by weight of polybutylene terephthalate resin could achieve satisfactory results in view of the flexibility test A, the oil resistance test B, and the oil resistance test C in the product form.

According to Comparative Example 1, flexibility was not sufficient because no polyester-ether thermoplastic polyester elastomer resin component was used. Moreover, the ratio of weight change of the material was low because the PBT resin has excellent oil resistance. However, the thermoplastic elastomer resin component was not contained, and therefore the bonding strength of the interface between the jacket and the cable was insufficient, and the oil resistance in the product form was also evaluated as insufficient.

According to Comparative Example 2, a large amount of elastomer resin component was used and therefore excellent flexibility was obtained. However, the contained amount of the elastomer resin component with respect to the PBT resin was more than 40 parts by weight, and therefore the weight change ratio of the material, the bonding strength of the interface between the jacket and the cable, and the oil resistance in the product form were all insufficient.

According to Comparative Example 3, no PBT resin was used, and, as expected, excellent flexibility was obtained. However, the weight change ratio of the material, the bonding strength of the interface of the jacket and the cable, and the oil resistance in the product form were all insufficient.

According to Comparative Example 4, the polybutylene terephthalate resin composition contained the thermoplastic elastomer by 10 parts by weight to 40 parts by weight with respect to 100 parts by weight of polybutylene terephthalate resin. However, the covered distance was as short as 1 mm, and therefore the jacket would be easily broken when a bending angle of the cable becomes larger and stress is concentrated on the interface. Accordingly, the flexibility, the weight change ratio of the material, and the bonding strength of the interface between the jacket and the cable were excellent, whereas the oil resistance in the product form was evaluated as insufficient.

According to the oil resistant electronic device of one or more embodiments of the present invention, the cable is covered with the jacket which contains the thermoplastic elastomer by 10 parts by weight to 40 parts by weight with respect to 100 parts by weight of polybutylene terephthalate resin. Therefore, the oil resistant electronic device is excellent in flexibility, water resistance, and oil resistance. This drastically contributes to improvement in quality of an electronic device such as a connector, which is often used under a severe condition in which the electronic device is exposed to a machine oil, a chemical solution, and the like for a long time under hot and humid environment. Further, one or more embodiments of the present invention contributes to improvement in manufacturing efficiency.

### REFERENCE SIGNS LIST

1: Connector body (Functioning section)
2: Jacket
3: Cable
4: Lead wire
5: Cable outer layer
6: Terminal
7: Cross section of cable end
8: Covered section
10: Connector
20: Sensor
21: Sensor body (Functioning section)
30: Screw-type planar gripper
40: Wedge-shaped gripper

While the invention has been described with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

1. An oil resistant electronic device comprising:
a functioning section which has a function of the oil resistant electronic device;
a cable via which an electric signal is transmitted to the functioning section; and
a jacket which covers the cable,
wherein the jacket being made of a polybutylene terephthalate resin composition containing a polyester-ether thermoplastic polyester elastomer and a polybutylene terephthalate resin where the polyester-ether thermoplastic polyester elastomer is contained by 10 parts by weight to 40 parts by weight with respect to 100 parts by weight of the polybutylene terephthalate resin, and
wherein the cable being covered with the jacket so that the jacket covers (i) an entire cross section of at least one end of the cable and (ii) an outer layer of the cable by 2.5 mm or more from the at least one end in a lengthwise direction, and
wherein the outer layer of the cable being made of polyvinyl chloride resin or polyurethane resin.

2. (canceled)

3. The oil resistant electronic device as set forth in claim 1, wherein said oil resistant electronic device is a connector or a sensor.

4. A method for producing an oil resistant electronic device, said method comprising the step of:
covering, with a polybutylene terephthalate resin composition, (i) an entire cross section of at least one end of a cable and (ii) an outer layer of the cable by 2.5 mm or more from the at least one end in a lengthwise direction,
wherein the polybutylene terephthalate resin composition containing a polyester-ether thermoplastic polyester elastomer by 10 parts by weight to 40 parts by weight with respect to 100 parts by weight of a polybutylene terephthalate resin, and
wherein the outer layer of the cable being made of polyvinyl chloride resin or polyurethane resin.
